(19) United States
(12) Patent Application Publication
(10) Pub. No.: US 2011/0081441 A1
(43) Pub. Date: Apr. 7, 2011

(54) ELECTRIC HOLLOW MOLDING MACHINE

(75) Inventors: Ping-Jung Lin, Yongkang City (TW); Po-Hung Lin, Yongkang City (TW); Po-Hang Lin, Yongkang City (TW)

(73) Assignee: JIH HUANG MACHINERY INDUSTRIAL CO., LTD., Yongkang City (TW)

(21) Appl. No.: 12/767,184

(22) Filed: Apr. 26, 2010

(30) Foreign Application Priority Data
Oct. 7, 2009 (TW) 098218446

(51) Int. Cl. B29C 49/32

(52) U.S. Cl. 425/541

(57) ABSTRACT

An electric hollow molding machine includes left and right molds, two operating arms connected respectively to the molds, a drive shaft unit driven by a power source to rotate, a movable seat including two first mounting sections to mount pivotally one operating arm to the movable seat, a threaded rod rotated by the drive shaft unit, a sleeve moved leftward or rightward by the threaded rod, first and second transmission seats movable along with the sleeve, at least one connecting shaft having one end connected to the second transmission seat, and a second mounting section connected to another end of the connecting shaft to mount pivotally the other operating arm to the connecting shaft. When the movable seat and the second transmission seat move telescopically relative to each other, the operating arms move the molds toward or away from each other to a mold closing or opening position.

### BACKGROUND OF THE INVENTION

1. Field of the Invention

This invention relates to a forming machine, more particularly to an electric hollow molding machine for forming hollow containers.

2. Description of the Related Art

A hydraulic means may be used to drive a first mold half toward or away from a second mold half which is fixed so as to close or open the molds of a conventional hollow molding machine. However, the hydraulic means requires oil pipes, so that the conventional hollow molding machine has many pipelines. Further, the related hydraulic equipment is quite large. Moreover, oil leakage is possible which can contaminate a base of the equipment. Hence, most manufacturers are currently using electric-controlled forming machines.

An example of a conventional electric hollow molding machine includes a left fixed mold, and a right movable mold that is driven to move toward or away from the left fixed mold to close or open the molds. This means that only one mold is moving to achieve closing or opening of the molds. In this case, during closing of the molds, the fixed mold must bear the closing impact of the movable mold. Although the fixed mold is fixed to a predetermined position, it will still deviate slightly upon impact of the movable mold so that the center of the two molds after closing of the molds also deviates, thereby affecting precision of a hollow container formed therefrom.

### SUMMARY OF THE INVENTION

Therefore, the object of the present invention is to provide an electric hollow molding machine that is capable of overcoming the aforementioned drawbacks of the prior art.

According to this invention, an electric hollow molding machine comprises a base, a mold device, a drive unit, a movable seat, a threaded rod, and first and second transmission units. The mold device is mounted to the base, and includes left and right molds, and two operating arms spaced apart from each other and connected respectively to the left and right molds. The operating arms move the left and right molds toward each other to a mold closing position, or away from each other to a mold opening position. The drive unit is proximate to the base, and includes a power source, a drive shaft unit driven by the power source to rotate, and an electromagnetic brake for stopping rotation of the drive shaft unit. The movable seat includes front and rear plates spaced apart from each other to confine a receiving chamber therebetween, and two first mounting sections connected respectively to outer sides of the front and rear plates to mount pivotally one of the operating arms to the movable seat. The threaded rod is disposed within the receiving chamber, and is rotated by the drive shaft unit. The first transmission unit includes a sleeve disposed around the threaded rod and moved leftward or rightward by the threaded rod, and a first transmission seat fixed around the sleeve and movable along therewith. The second transmission unit is movable leftward and rightward along with the first transmission unit, and includes a second transmission seat disposed around the sleeve and on one side of the first transmission seat and cooperating with the first transmission seat to define therebetween a damping space, and a damping element disposed within the damping space. The second transmission unit further includes at least one connecting shaft having one end connected to the second transmission seat and another end extending out of the movable seat, and a second mounting section connected to the another end of the connecting shaft to mount pivotally the other one of the operating arms to the connecting shaft. When the movable seat and the second transmission unit move telescopically relative to each other, the operating arms move the left and right molds toward or away from each other to the mold closing or opening position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of an electric hollow molding machine according to the preferred embodiment of the present invention;

FIG. 2 is a schematic front view of the electric hollow molding machine of the preferred embodiment;

FIG. 3 is a fragmentary sectional view of the preferred embodiment, illustrating a connection between a drive unit and a transmission assembly;

FIG. 4 is a perspective view of the drive unit and the transmission assembly of the preferred embodiment; and

FIG. 5 is a view similar to FIG. 4, but illustrating a plurality of connecting shafts of the transmission assembly extending out of a movable seat thereof.

### DETAILED DESCRIPTION OF THE PREFERRED EMBODIMENT

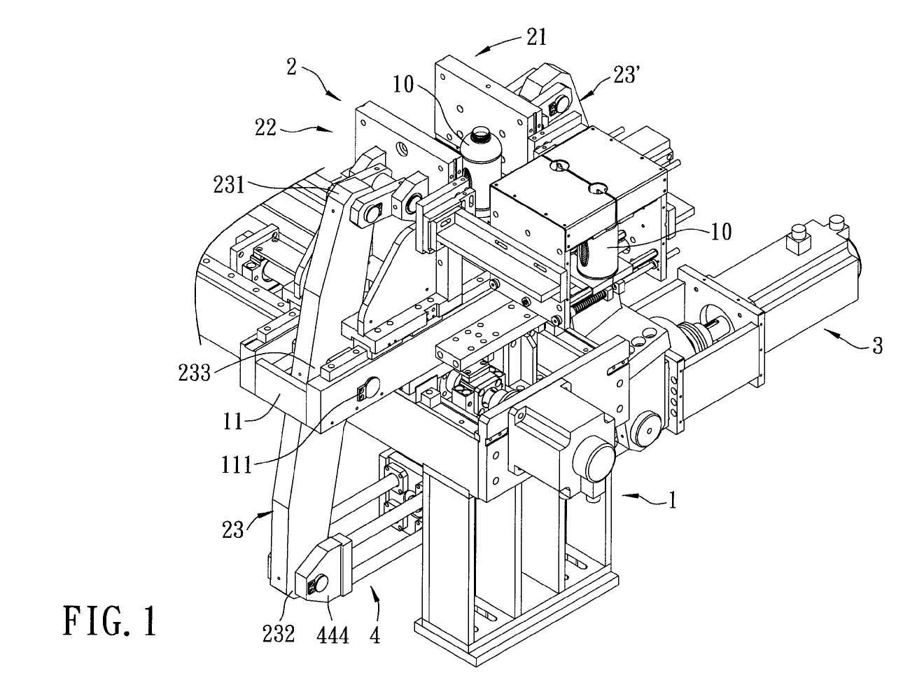

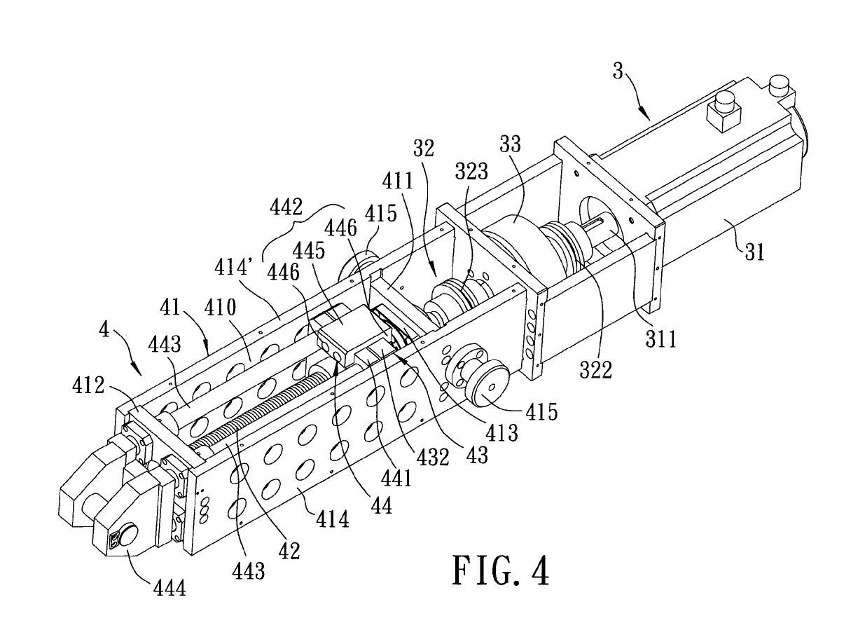

Referring to FIGS. 1 to 5, an electric hollow molding machine according to the preferred embodiment of the present invention for forming a hollow container 10 is shown to comprise a base 1, a mold device 2, a drive unit 3, and a transmission assembly 4.

The base 1 includes a mold support frame 11 having mounting portions 111 spaced apart from each other in a left-right manner.

The mold device 2 includes left and right molds 22, 21 mounted to the mold support frame 11, and left and right operating arms 23, 23′ spaced apart from each other and connected respectively to the left and right molds 22, 21. The left and right molds 22, 21 are slidable relative to each other in a left-right direction along the mold support frame 11, and are movable toward each other to cooperatively confine a forming space (not shown) for forming the hollow container 10. Each operating arm 23, 23′ includes a mold-connecting portion 231 connected to a respective one of the left and right molds 22, 21, a driven portion 232 opposite to the mold-connecting portion 231, and a fulcrummed portion 233 between the mold-connecting portion 231 and the driven portion 232. The fulcrummed portions 233 of the operating arms 23, 23′ are connected pivotally and respectively to the mounting portions 111 of the mold support frame 11.

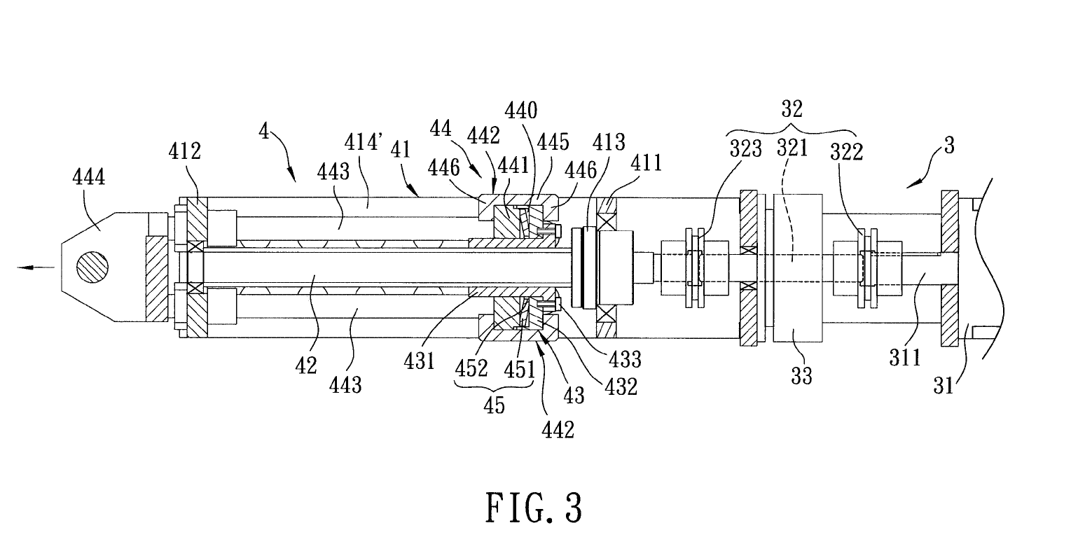

The drive unit 3 is proximate to the base 1, and includes a power source 31 installed on a front side of the mold device 2, a drive shaft unit 32 driven by the power source 31 to rotate, and an electromagnetic brake 33. The power source 31 is a servo motor that may be driven by an electric power and that is actuated by a digital control, but is not limited as such. The power source 31 includes a power shaft 311 (see FIG. 3) projecting leftwardly. The drive shaft unit 32 includes a drive shaft 321, a first shaft coupling 322 that couples a right end of the drive shaft 321 to the power shaft 311, and a second shaft coupling 323 connected to a left end of the drive shaft 321. The electromagnetic brake 33 is mounted to the drive shaft 321 for stopping rotation of the drive shaft 321.

The transmission assembly 4 includes a movable seat 41, a threaded rod 42, a first transmission unit 43, and a second transmission unit 44. The movable seat 41 includes left and right plates 412, 411 spaced apart from each other, a rod-supporting seat 413 fixed to the right plate 411, front and rear plates 414, 414° interconnecting and cooperating with the left and right plates 412, 411 to confine a receiving chamber 410, and two first mounting sections 415 connected respectively to outer sides of the front and rear plates 414, 414′ to mount pivotally the driven portion 232 of the right operating arm 23′ to the movable seat 41.

The threaded rod 42 is disposed between the left and right plates 411, 412 within the receiving chamber 410, and has a right end extending rotatably through the rod-supporting seat 413. The second shaft coupling 323 couples the right end of the threaded rod 42 to the drive shaft 321, as shown in FIG. 3.

The first transmission unit 43 includes a sleeve 431 and a first transmission seat 432. The sleeve 431 is disposed around the threaded rod 42, and is moved leftward or rightward by the threaded rod 42. The sleeve 431 has an internally extending thread connected to the threaded rod 42. The first transmission seat 432 is fixed around the sleeve 431 through a plurality of screws 433, and is movable along therewith.

The second transmission unit 44 is movable leftward and rightward along with the first transmission unit 43, and includes a second transmission seat 441 disposed around the sleeve 431 and on a left side of the first transmission seat 432 and cooperating with the first transmission seat 432 to define therebetween a damping space 440, two substantially U-shaped coupling seats 442 spaced apart from each other in a top-to-bottom direction, four spaced-apart connecting shafts 443, and a second mounting section 444. Each coupling seat 442 has a bight section 445, and left and right arm sections 446 projecting respectively from two opposite ends of the bight section 445. The first and second transmission seats 432, 441 are clamped between the left and right arm sections 446 of the coupling seats 442. The bight section 445 of the coupling seats 442 are situated respectively on top and bottom ends of the first and second transmission seats 432, 441. Each connecting shaft 443 has a right end connected to the second transmission seat 441, and a left end extending through the left plate 412 and out of the movable seat 41. The second mounting section 444 is connected to the left ends of the connecting shafts 443 to mount pivotally the driven portion 232 of the left operating arm 23 to the connecting shafts 443. Hence, the driven portions 232 of the left and right operating arms 23, 23′ are connected respectively to the first and second mounting sections 415, 444 of the movable seat 41 and the second transmission unit 44.

A damping element 45 includes a disc spring disposed around the sleeve 431 within the damping space 440 and having a convex annular wall 451, and a through hole 452 formed in the convex annular wall 451.

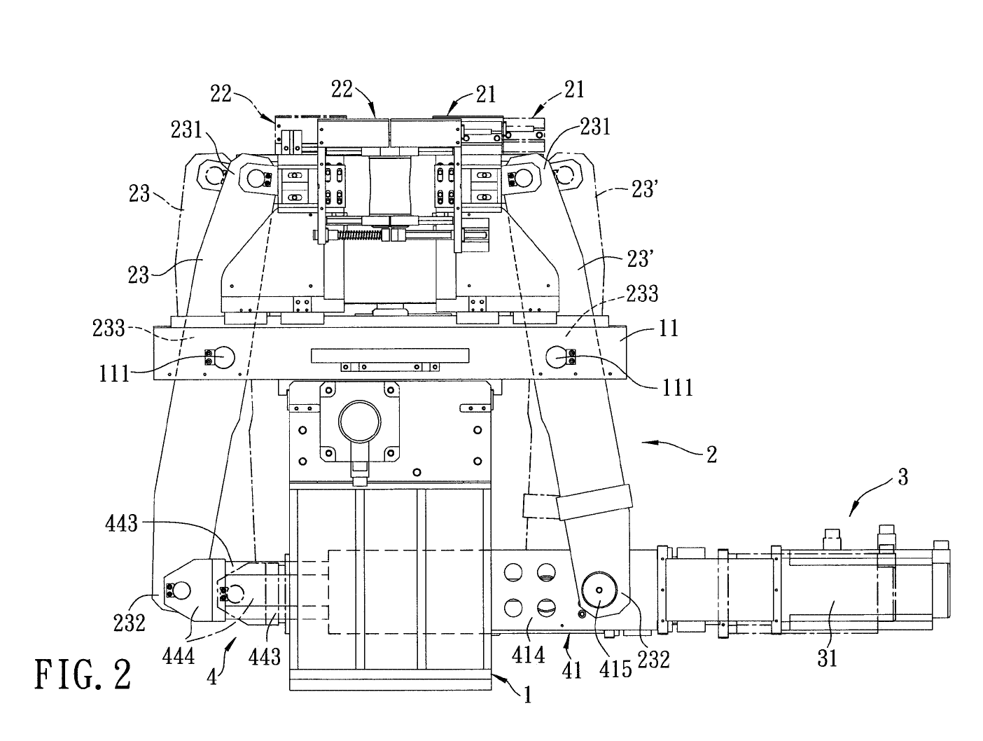

With reference to FIGS. 1 and 2, the left and right operating arms 23, 23′ of the mold device 2 can be actuated by the drive unit 3 so as to move the left and right molds 22, 21 toward each other to a mold closing position, or away from each other to a mold opening position, as shown in imaginary lines in FIG. 2. When the molds 21, 22 are in the mold opening position, the driven portions 232 of the operating arms 23, 23′ are moved toward each other, while the mold-connecting portions 231 thereof are moved away from each other. Thus, the left and right molds 22, 21 are moved away from each other, the first and second transmission seats 432, 441 are proximate to the right plate 411, the connecting shafts 443 are disposed within the receiving chamber 410, and the second mounting section 444 is proximate to the left plate 412.

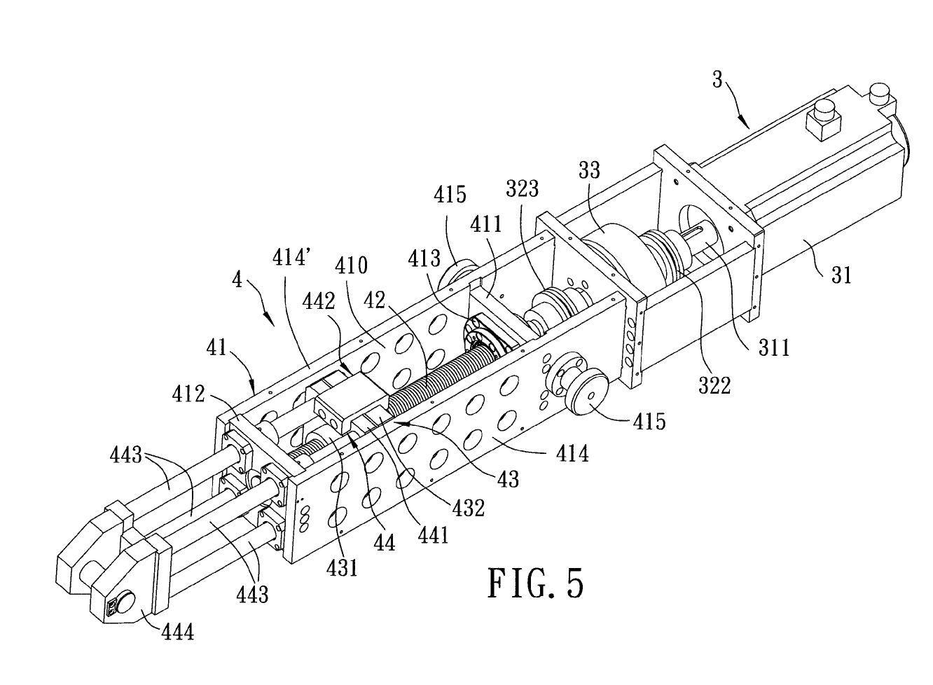

To shift the molds 21, 22 from the mold opening position to the mold closing position, the power source 31 is activated so that the drive shaft unit 32 can rotate the threaded rod 42 about its axis in a first direction. As the threaded rod 42 rotates, it moves the sleeve 431 leftwardly, as shown by an arrow in FIG. 3, toward the left plate 412. The sleeve 431, in turn, moves the first and second transmission seats 432, 441 therealong. As the sleeve 431 moves near the left plate 412, the left ends of the connecting shafts 443 are pushed out of the movable seat 41, and the second mounting section 444 is pushed by the connecting shafts 443 to move away from the left plate 412, as shown in FIG. 5. With reference to FIG. 2, as the left ends of the connecting shafts 443 are pushed out of the movable seat 41, the driven portions 232 of the operating arms 23, 23′ are moved away from each other, while the mold-connecting portions 231 of the operating arms 23, 23′ are moved toward each other, thereby moving the left and right molds 22, 21 to the mold closing position.

It should be noted that since the movable seat 41 is not fixed to the base 1, when the left ends of the connecting shafts 443 move out of the movable seat 41, the movable seat 41 receives a counterforce so that it moves to the right. Because the second mounting section 444 and the movable seat 41 move oppositely, the driven portions 232 of the operating arms 23, 23′ are moved away from each other, and the mold-connecting portions 231 of the operating arms 23, 23′ move toward each other, with the operating arms 23, 23′ pivoting about the fulcrummed portions 233 thereof, thereby moving the left and right molds 22, 21 toward each other to the mold closing position. After the left and right molds 22, 21 are disposed in the mold closing position, subsequent operations for forming the hollow container 10 can be performed.

When the power source 31 actuates the threaded rod 42 to rotate about its axis in a second direction which is opposite to the first direction, the connecting shafts 443 are brought to move rightward relative to the movable seat 41, and the movable seat 41 is moved leftward relative to the connecting shafts 443, so that the first and second mounting sections 415, 444 move close to each other, thereby moving the driven portions 232 of the operating arms 23, 23′ toward each other, and the mold-connecting portions 231 of the operating arms 23, 23′ away from each other, which in turn move the left and right molds 22, 21 away from each other to the mold opening position, as shown in FIG. 2 in imaginary lines.

Further, in the forming operation of the hollow container 10, the left and right molds 22, 21 absorb a large forming counterforce. The counterforce pushes the left and right molds 22, 21 away from each other, and is transmitted to the operating arms 23, 23′, the second transmission unit 44, and the first transmission unit 43. The advantage of providing the damping element 45 in the electric hollow molding machine of the present invention resides in that when the forming counterforce is transmitted to the aforesaid components, the damping element 45 can dampen the counterforce, thereby preventing the first transmission unit 43, the drive shaft unit 32, and the power shaft 311 from direct impact. As a result, machine fatigue can be prevented, and the service lives of the components can be prolonged. Moreover, during the mold closing position, a pushing force of the first transmission unit 43 is transmitted to the second transmission unit 44 through the damping element 45 so as to prevent a direct rigid transmission to thereby dampen a mold closing force. As such, the service lives of the components can be prolonged. Additionally, the electromagnetic brake 33 can control the drive shaft 321 to stop its rotation, and can eliminate bouncing during closing of the first and second molds 21, 22 so as to prevent damage to the power source 31.

In summary, through the simultaneous connection of the drive unit 3 and the transmission assembly 4 with the operating arms 23, 23′ and bringing the same to move respectively therealong, the left and right molds 22, 21 can be moved toward or away from each other so as to be disposed in the close or mold opening position. Further, since the left and right molds 22, 21 move simultaneously toward each other, the connection force thereof is provided by both of the left and right molds 22, 21. Hence, the center of the two molds 21, 22 after the connection can be accurately controlled at a predetermined position, so that the formed hollow container 10 has a high precision. Moreover, since the damping element 45 has the function of dampening an external force, and since the electromagnetic brake 33 has the function of stopping rotation of the drive shaft 321, damage to the components can be prevented so that the service lives of the components can be prolonged.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. An electric hollow molding machine comprising:
a base;
a mold device mounted to said base and including left and right molds, and two operating arms spaced apart from each other and connected respectively to said left and right molds, said operating arms moving said left and right molds toward each other to a mold closing position, or away from each other to a mold opening position;
a drive unit proximate to said base and including a power source, a drive shaft unit driven by said power source to rotate, and an electromagnetic brake for stopping rotation of said drive shaft unit;
a movable seat including front and rear plates spaced apart from each other to confine a receiving chamber therebetween, and two first mounting sections connected respectively to outer sides of said front and rear plates to mount pivotally one of said operating arms to said movable seat;
a threaded rod disposed within said receiving chamber and rotated by said drive shaft unit;
a first transmission unit including a sleeve disposed around said threaded rod and moved leftward or rightward by said threaded rod, and a first transmission seat fixed around said sleeve and movable along therewith; and
a second transmission unit movable leftward and rightward along with said first transmission unit and including a second transmission seat disposed around said sleeve and on one side of said first transmission seat and cooperating with said first transmission seat to define therebetween a damping space, and a damping element disposed within said damping space;
said second transmission unit further including at least one connecting shaft having one end connected to said second transmission seat and another end extending out of said movable seat, and a second mounting section connected to said another end of said connecting shaft to mount pivotally the other one of said operating arms to said connecting shaft;
wherein, when said movable seat and said second transmission unit move telescopically relative to each other, said operating arms move said left and right molds toward or away from each other to the mold closing or opening position.

2. The electric hollow molding machine of claim 1, wherein said damping element includes a disc spring having a convex annular wall.

3. The electric hollow molding machine of claim 1, wherein said base includes two mounting portions spaced apart from each other, each of said operating arms including a mold-connecting portion connected to a respective one of said left and right molds, a driven portion opposite to said mold-connecting portion, and a fulcrummed portion between said mold-connecting portion and said driven portion and connected pivotally to one of said mounting portions of said base, said driven portions of said operating arms being connected respectively to said first and second mounting sections of said movable seat and said second transmission unit, wherein, when said left and right molds are in the mold opening position, said driven portions of said operating arms are moved toward each other and said mold-connecting portions of said operating arms are moved away from each other, and when said left and right molds are in the mold closing position, said driven portions of said operating arms are moved away from each other and said mold-connecting portions of said operating arms are moved toward each other.

4. The electric hollow molding machine of claim 1, wherein said movable seat further includes left and right plates interconnecting and cooperating with said front and rear plates of said movable seat to confine said receiving chamber, said threaded rod being disposed between said left and right plates.

5. The electric hollow molding machine of claim 1, wherein said second transmission unit further includes a substantially U-shaped coupling seat having a bight section, and left and right arm sections projecting respectively from two opposite ends of said bight section, said first and second transmission seats being clamped between said left and right arm sections.
